(19) United States
(12) Patent Application Publication
(10) Pub. No.: US 2021/0237857 A1
(43) Pub. Date: Aug. 5, 2021

(54) HIGH-LIFT SYSTEM FOR AN AIRCRAFT WITH AN RFID SUPPLEMENTED TRIP INDICATOR OF A TORQUE LIMITING DEVICE

(71) Applicant: Airbus Operations GmbH, Hamburg (DE)

(72) Inventors: Jan HASERODT, Hamburg (DE); Martin RECKSIEK, Hamburg (DE); Björn DORR, Hamburg (DE)

(21) Appl. No.: 17/159,843

(22) Filed: Jan. 27, 2021

(30) Foreign Application Priority Data
Jan. 30, 2020 (DE) 102020102319.7

(51) Int. Cl. B64C 19/00; B64D 45/00; G05B 15/02

(52) U.S. Cl. CPC B64C 19/00; G05B 15/02; B64D 45/00

(57) ABSTRACT

A high-lift system for an aircraft incudes at least one mechanical torque limiting device, which includes a visual trip indicator for visually signaling a torque limiter trip, the high-lift-system further comprising an RFID tag device, which is configured to be switched into a functional state, in which it is readable by an external RFID tag reader, and into a nonfunctional state, in which it is not readable by an external RFID tag reader, and a coupling device, which is electrically connectable to the RFID tag device. The coupling device is configured to be physically coupled with the visual trip indicator, and to switch the RFID tag device into the functional state, if the visual trip indicator signals a trip, and into the nonfunctional state, if the visual trip indicator does not signal a trip.

### CROSS-REFERENCES TO RELATED APPLICATIONS

This application claims the benefit of the German patent application No. 102020102319.7 filed on Jan. 30, 2020, the entire disclosures of which are incorporated herein by way of reference.

### FIELD OF THE INVENTION

The invention relates to a high-lift system for an aircraft as well as an aircraft having such a high-lift system.

### BACKGROUND OF THE INVENTION

High-lift systems for an aircraft often comprise one or more drive devices, which are mechanically coupled with movable flow bodies, such as leading-edge slats and trailing-edge flaps, arranged on the wings of the aircraft. The drive devices are capable of moving the flow bodies from a retracted position into at least one extended position to increase the surface area and/or the camber of the respective wing. In some unlikely circumstances, drive devices may face an excessive torque. For avoiding mechanical damages, they are equipped with torque limiting devices. These may be arranged at various locations in the high-lift system.

Torque limiting devices may comprise a mechanism that allows the arrest of a driven element if the torque exceeds a predetermined maximum. If such a situation occurs, a so-called visual trip indicator is triggered, which visually signals that the torque limiting device experienced a trip. After being triggered, the visual trip indicator remains in the visually indicating state until it is manually pushed back. The indicator guides a mechanic to track down a possible cause for the excessive torque. However, it is required to subsequently remove several skin panels of the respective wing for being able to localize and identify the affected torque limiting device. This is a time-consuming and cumbersome task.

### SUMMARY OF THE INVENTION

The integration of active sensors in all torque limiting devices would enable a mechanic to quickly identify a tripped torque limiting device. However, this would require numerous modifications and additional channels to be monitored by a control unit integrated in the respective aircraft.

Hence, it is an object of the invention to provide a high-lift system for an aircraft, which allows to quickly identify a tripped torque limiting device without the need for active sensors or the requirement for substantially modifying common torque limiting devices that are equipped with the visual trip indicators and without requiring to subsequently remove numerous skin panels.

A high-lift system for an aircraft is proposed, comprising at least one mechanical torque limiting device, which includes a visual trip indicator for visually signaling a torque limiter trip, the high-lift-system further comprising an RFID tag device, comprising an RFID tag, which is designed and configured to be switched into a functional state, in which it is readable by an external RFID tag reader, and into a nonfunctional state, in which it is not readable by an external RFID tag reader, and a coupling device, which is electrically connectable to the RFID tag device, wherein the coupling device is designed and configured to be physically coupled with the visual trip indicator, and to switch the RFID tag device into the functional state, if the visual trip indicator signals a trip, and into the nonfunctional state, if the visual trip indicator does not signal a trip.

Consequently, the high-lift system according to the invention still relies on the use of a common visual trip indicator. The torque limiter itself does not require a modification. Instead, a combination of a coupling device and an RFID tag device is proposed to facilitate the localization and identification of a torque limiting device that has experienced a trip. It allows to equip the high-lift system with a second means for recognizing or confirming a visual indication of a state to be checked.

This is done as described in the following. The coupling device is designed and configured to be physically coupled with the visual trip indicator. This means that the coupling device is capable of physically receiving an information about the status of the trip indicator. In this regard, the term “physically” is directed to a plurality of different coupling mechanisms, which inter alia include, but are not limited to, mechanical, optical and electrical connections.

The RFID tag device, in turn, may comprise an antenna and a transmitting circuit, which includes a memory device. It is capable of receiving and storing power that is transferred from an external RFID tag reader into the antenna of the RFID tag device. The received and stored energy is used for conducting a transmission of a signal with information saved in the memory device.

It is advantageous to directly place the RFID tag device on the respective torque limiting device and to provide an identification into the memory device, which allows an assignment between the respective RFID tag device and a torque limiting device. A user may thus walk along the wing of the aircraft, in which the high-lift system is provided, to subsequently hold an RFID tag reader at dedicated positions of the wing and operate the RFID tag reader.

The RFID tag device is capable of selectively being switched into a functional and a nonfunctional state. In the functional state the RFID tag device is capable of transmitting a signal. If it is in the functional state, a user is able to receive a signal from it if the RFID tag reader is in the transmission range. However, if the RFID tag device is in the nonfunctional state, the user will not receive a signal from it. Hence, a user will only receive a signal through the RFID tag reader if it is held in a transmission range of an RFID tag device that is switched into the functional state.

Switching the RFID tag device between these two states may be conducted through various techniques. A simple technique may be realized by selectively bridging the antenna of the RFID tag device, such that a signal cannot be transmitted. Also, a connection to the antenna may be selectively interrupted completely to selectively avoid a signal transmission. It may also be possible to provide a control unit in the RFID tag device that queries a contact on a separate input of the RFID tag device and conduct or prevent a signal transmission, depending on the result of the query.

According to the invention, the RFID tag device is connected to the coupling device, such that depending on the visual trip indicator state, the RFID tag device is switched into the functional state or the nonfunctional state. Accordingly, the user walking along the wing may receive a signal from the RFID tag devices only at those positions where a torque limiting device with a visual trip indicator indicates a trip. A user does not need to remove a skin panel on a position that is not associated with a tripped torque limiting device. The high-lift system according to the invention is thus clearly improved, but merely requires a simple addition, which does not interfere with any element of the primary function of the torque limiting device.

In an advantageous embodiment, the coupling device is mechanically, optically, magnetically or electrically connected to the visual trip indicator. A mechanical connection may be realized by a mechanical component, such as a pin, a lever, a rod or any other element that is able to exert a mechanical force onto the RFID tag device. For example, the RFID tag device itself may comprise an electric switch or the like, which is mechanically operable by the coupling device. The coupling device may then be realized by the mechanical component. An optical connection may be understood as providing a completely touchless connection by monitoring the visually recognizable state of the visual trip indicator, by using a proximity sensor, a light barrier or the like. The RFID tag device or the coupling device may then comprise a certain switching unit, which is capable of interacting with the RFID tag device for switching it into an active, i.e., functional, or a deactivated, i.e., non-functional, state through the optical connection. Lastly, the electrical connection may include providing an electrical contact between an element of the coupling device and the visual trip indicator. The electrical contact does not necessarily close an electrical circuit directly, but it may also be used for a capacity switch or the like. Altogether, there are numerous variants of connecting the RFID tag device with the visual trip indicator.

Advantageously, the RFID tag device may comprise an electric switch, which is designed and configured to selectively establish or interrupt an internal connection in the RFID tag device. The electric switch allows to selectively open or close an electric circuit, which is inside the RFID tag device and which is required for its function. For example, a connection between an antenna and a transmission circuit may be interruptible. Thus, by opening the electric switch, the RFID tag device cannot receive electrical power through the antenna anymore and is not capable of transmitting a signal. In another variant, the visual trip indicator and the electrical switch are arranged in such a way that the electrical switch closes, if the visual trip indicator indicates a trip. For example, the visual trip indicator moves from a retracted into an extended position. The electrical switch may be arranged underneath the visual trip indicator or it may be actuated by a mechanical element that is bonded to the visual trip indicator, and the electrical switch is arranged directly adjacent to the visual trip indicator. If the visual trip indicator moves into the extended position, the switch reverts to a closed state. If the visual trip indicator is retracted, it exerts a holding force onto the electrical switch, such that it remains in the pressed open state. In another variant, the electrical switch may bridge two electrical connections, such that, for example, the antenna experiences a short circuit. Consequently, the RFID tag device is not capable of receiving electrical power and of transmitting a signal if the switch is closed. The arrangement of the electrical switch and the visual trip indicator may be provided in the same way as in the first variant, but the switch should provide the opposite function, i.e., it is a switch that closes a contact in the neutral state and opens a connection when it is pressed by the visual trip indicator.

In an advantageous embodiment, the coupling device comprises a pin, which is attached to the visual trip indicator, and wherein the RFID tag device is bonded to the torque limiting device in such a position that the pin is able to operatively reach the electric switch. The pin may be understood as a short mechanical element, which is designed and configured to simply act on the electrical switch. The pin may be attached to the visual trip indicator such that it extends from a boundary surface of it and reaches the electrical switch at least in a retracted state. Advantageously, it may be glued to the visual trip indicator.

In this regard, the shape of the pin and the position of the RFID tag device are adapted such that the pin opens the electric switch if the visual trip indicator indicates a trip. As explained above, this would lead to opening an electric circuit, which is required for receiving electrical power and for transmitting a signal.

Preferably, the electric switch comprises a key button and opens an electric contact if it is pressed. The key button is an electrical switch, which comprises a spring-loaded push-button, which always reverts to a neutral state if not pushed, i.e., released. In this variant, the key button closes electrical contact if released. Hence, in case the visual trip indicator is extended, it releases the key button, which then leads to closing an electrical contact. The RFID tag device is then in an active, i.e., functional, state and is capable of receiving electrical power and transmitting a signal.

In another advantageous embodiment, the RFID tag device comprises a photo sensor, which is designed and configured to selective establish or interrupt an internal connection in the RFID tag device. The photo sensor may be adapted to recognize a proximity of the visual trip indicator, which allows to contactless switch the RFID tag device into the functional or the non-functional state by the visual trip indicator. It may be possible to add a light source to the RFID tag device, which is capable of illuminating a region of interest. It may be small in size and comprise a low energy consuming LED or the like, which can be powered by the RFID tag device. It is sufficient to let the photo sensor merely distinguish between a present visual trip indicator or a lack of it directly in front of the photosensor. It may be worthwhile to attach a light reflecting foil or similar item to the visual trip indicator to facilitate the recognition.

In a further advantageous embodiment, the photo sensor comprises a light barrier, which is interruptible by the visual trip indicator. Thus, the visual trip indicator and the light barrier may be arranged in a way that the visual trip indicator interrupts the light barrier in either the retracted or an extended state.

Advantageously, the RFID tag device is a passive RFID tag device. It is solely powered by an amount of energy transferred from an external RFID tag reader and received through the antenna.

Finally, the invention relates to an aircraft having two wings and at least one high-lift system according to the above description.

### BRIEF DESCRIPTION OF THE DRAWINGS

Other characteristics, advantages and potential applications of the present invention result from the following description of the exemplary embodiments illustrated in the figures. In this respect, all described and/or graphically illustrated characteristics also form the object of the invention individually and in arbitrary combination regardless of their composition in the individual claims or their references to other claims. Furthermore, identical or similar objects are identified by the same reference symbols in the figures.

FIG. 1a shows a schematic view of a trailing-edge part of a high-lift system.

FIG. 1b shows a schematic view of a leading-edge part of a high-lift system.

FIG. 2 shows a detail of a torque limiting device with a coupling device and an RFID tag device.

FIG. 3 shows an aircraft having a high-lift system.

### DETAILED DESCRIPTION OF THE PREFERRED EMBODIMENTS

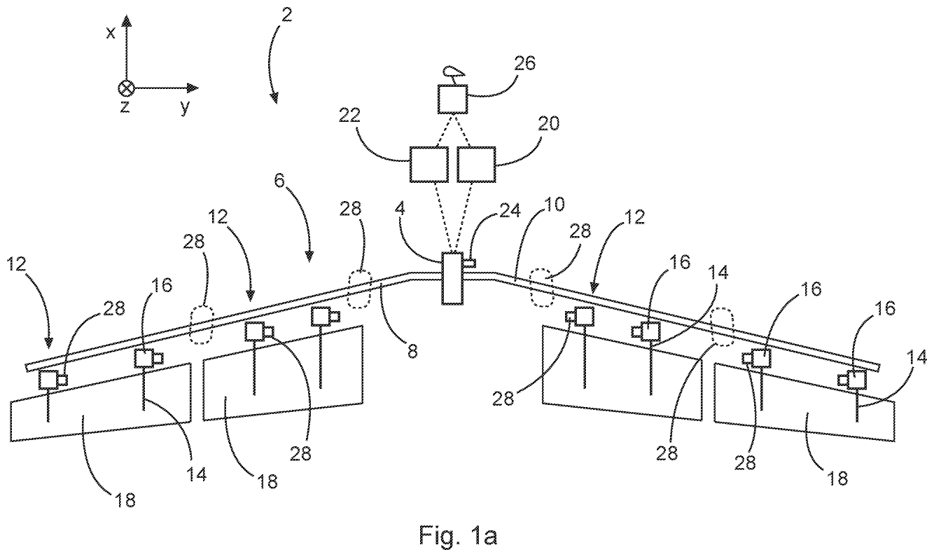

FIG. 1a exemplarily shows a trailing-edge part of a high-lift system 2, which is equipped with the above-identified features according to the invention. The high-lift system 2 comprises a number of general features of a high-lift system known to a skilled person. However, this is merely an example and the high-lift system 2 may also be designed and configured differently.

In this example, the high-lift system 2 comprises a central drive unit 4 (PCU), which is coupled to a transmission shaft system 6 comprising a left transmission shaft 8 and a right transmission shaft 10. These transmission shafts 8 and 10 are coupled to driving stations 12 that are exemplarily distributed over leading and/or trailing wing edges along the transmission shafts 8 and 10.

Each driving station 12 exemplarily comprises a rotary actuator 16 that may be driven by the respective transmission shaft 8, 10 and is coupled to a flow body, such as a flap 18, by means of a connecting link 14 in the form of a push rod or a similar element. For example, each flap 18 may be coupled with two rotary actuators 16. Both driving stations 12 of the flap 18 are spaced apart from one another and preferably assigned to two laterally opposed flap ends. It is common practice to use two redundant flap control units 20 and 22 that are coupled to the drive unit 4. A feedback position pickoff unit 24 is connected to the flap control units 20 and 22 and allows to determine an instantaneous rotatory position of the transmission shaft system 6, based on which the position of the flaps 18 may be determined. A flap adjusting lever 26 arranged in a cockpit of the associated aircraft serves for adjusting the flaps 18 and delivers a corresponding signal to the flap control units 20 and 22, which in turn activate the drive unit 4 in such a way that the rotatory position of the transmission shaft system 6 corresponds to the desired angle commanded by the flap adjusting lever 26.

For preventing an excessive torque at the rotary actuators 16, these may each be coupled with a torque limiting device 28. Again, this is an example. The transmission shafts 8 and 10 may optionally also be equipped with torque limiting devices 28 at one or more positions, which are exemplarily shown with dashed lines. They may be designed and configured to interrupt the transfer of torque upon exceeding a predetermined maximum torque at an input shaft. If such a torque limiting device trip occurs, a visual trip indicator is extended from a retracted position on the respective torque limiting device for a visual indication.

In analogy to this setup, FIG. 1b shows a leading-edge part of the high-lift system with a central drive unit 4b and a transmission shaft system 6b with a left transmission shaft 8b and a right transmission shaft 10b, which drive several rotary actuators 16b coupled with movably supported slats 18b. Each of the rotary actuators 16b are equipped with a torque limiting device 28 with visual trip indicators 30 according to the above description.

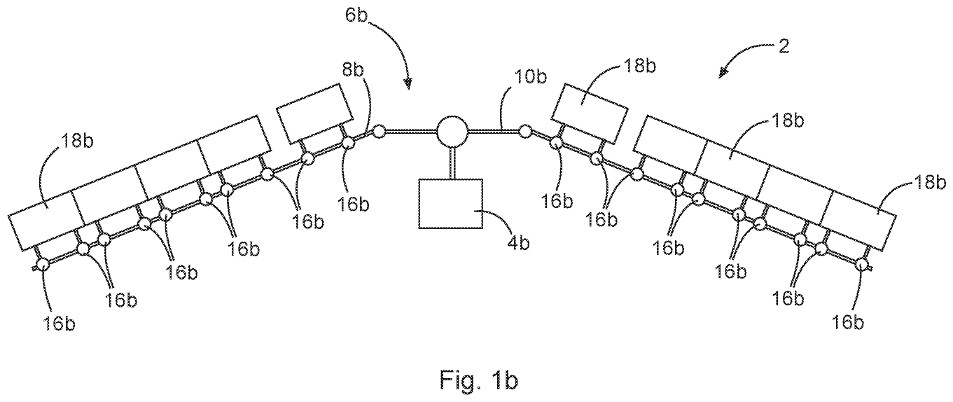

FIG. 2 shows such a visual trip indicator 30 in a retracted position, in which it exemplarily flushly rests in a recess, under a surface or otherwise hidden or not visually protruding. If the respective torque limiting device 28 trips, the visual indicator 30 is extended into an extended position that is shown with dashed lines.

Due to the geometrical extension of the high-lift system 2, in particular in a spanwise direction, as well as the number of skin panels to be removed for identifying a tripped torque limiting device 28, common high-lift systems require a time-consuming task for a suitable maintenance operation. However, the torque limiting device 28 shown in FIG. 2 comprises a slight modification of the high-lift system 2 for providing a second source of information about a tripped torque limiting device. This second source of information can be retrieved without having to remove skin panels underneath the torque limiting devices 28 by using RFID tag devices 32, which may each include an RFID tag, on the torque limiting devices 28, wherein the RFID tag devices 32 are capable of transmitting a signal, if a trip occurs.

The RFID tag device 32 is designed and configured to be switchable into a functional state, in which it is readable by an external RFID tag reader and into a non-functional state, in which it is not readable by external RFID tag reader. For this, the RFID tag device 32 exemplarily comprises two electrical ports 34 and 36, which are coupled with an electrical switch 38. By closing the switch 38, the RFID tag device 32 is in a non-functional state. By opening the switch 38, the RFID tag device 32 is in a functional state. For example, the electrical switch 38 is connected to two opposite branch lines of an internal antenna, which is not shown in FIG. 2, in order to selectively produce a short circuit. In doing so, the RFID tag device 32 is not capable of receiving electrical power delivered by an external RFID tag reader and, consequently, cannot transmit a signal.

For operating the electrical switch 38, a coupling device 40 is provided, which is exemplarily realized in the form of a pin or a lever. The coupling device 40 is attached to a bottom surface 42 of the visual trip indicator 30 and arranged to directly contact the electrical switch 38 when the indicator 30 is in the retracted position. In this state, a user is not capable of receiving a signal in the transmission range of the respective RFID tag device 32. A user may thus only receive a signal where a torque limiting device 28 has tripped. Hence, a user may quickly identify the respective skin panel to be removed in order to provide maintenance to the high-lift system 2 by walking along the high-lift system 2 and trying to receive a signal at all locations of the torque limiting devices 28 through an external RFID tag reader. Only where a signal is received a tripped torque limiting device 28 may be present and the associated skin panel needs to be removed to check for a maintenance operation. A great advantage lies in the saving of trouble shooting time and in the fact that only a small modification of the torque limiting devices would be needed to add the sensor.

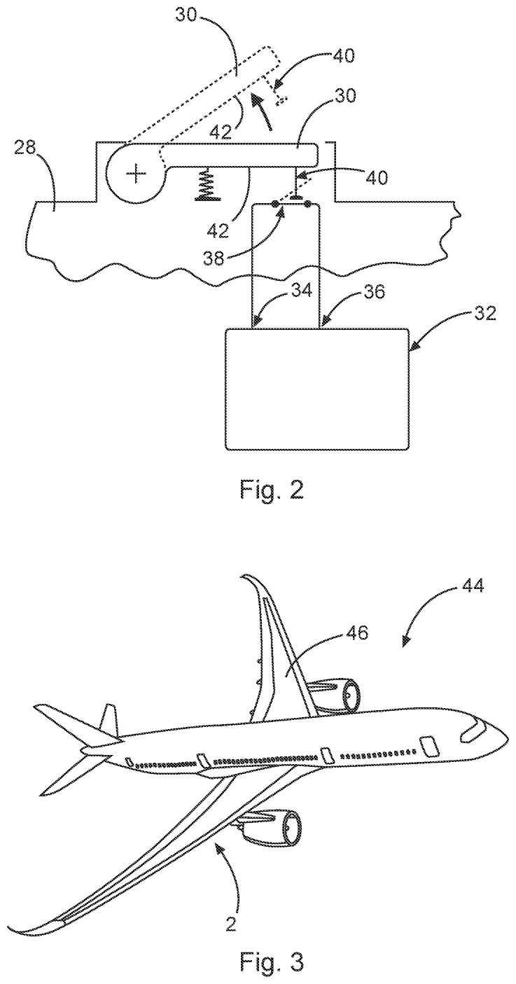

FIG. 3 shows an aircraft 44 having wings 46, to which a high-lift system 2 is provided.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described with reference to one of the above exemplary embodiments may also be used in combination with other characteristics or steps and in any order unless the disclosure or context suggests otherwise. This disclosure hereby incorporates by reference the complete disclosure of any patent or application from which it claims benefit or priority.

### REFERENCE NUMERALS

2 high-lift system
4 central drive unit
4b central drive unit
6 transmission shaft system
6b transmission shaft system
8 left transmission shaft
8b left transmission shaft
10 right transmission shaft
10b right transmission shaft
12 driving station
14 connecting link
16 rotary actuator
16b rotary actuator
18 flap
18b slat
20 flap control unit
22 flap control unit
24 feedback position pickoff unit
26 flap adjusting lever
28 torque limiting device
30 visual trip indicator
32 RFID tag device
34 electrical port
36 electrical port
38 electrical switch
40 coupling device/pin
42 bottom surface
44 aircraft
46 wing

1. A high-lift system for an aircraft, comprising:
at least one mechanical torque limiting device, which includes a visual trip indicator for visually signaling a torque limiter trip,
an RFID tag device configured to be switched into a functional state, in which the RFID tag device is readable by an external RFID tag reader, and into a nonfunctional state, in which the RFID tag device is not readable by an external RFID tag reader, and
a coupling device electrically connectable to the RFID tag device,
wherein the coupling device is configured to be physically coupled with the visual trip indicator, and to switch the RFID tag device into the functional state, if the visual trip indicator signals a trip, and into the nonfunctional state, if the visual trip indicator does not signal a trip.

2. The high-lift system according to claim 1, wherein the coupling device is mechanically, optically, magnetically or electrically connected to the visual trip indicator.

3. The high-lift system according to claim 1, wherein the RFID tag device comprises an electric switch which is configured to selectively establish or interrupt an internal connection in the RFID tag device.

4. The high-lift system according to claim 3,
wherein the coupling device comprises a pin which is attached to the visual trip indicator, and
wherein the RFID tag device is bonded to the torque limiting device in such a position that the pin operatively reaches the electric switch.

5. The high-lift system according to claim 4, wherein a shape of the pin and the position of the RFID tag device are configured such that the pin opens the electric switch if the visual trip indicator indicates a trip.

6. The high-lift system according to claim 5, wherein the electric switch comprises a key button and opens an electric contact if it is pressed.

7. The high-lift system according to claim 1, wherein the RFID tag device comprises a photo sensor, which is configured to selective establish or interrupt an internal connection in the RFID tag device.

8. The high-lift system according to claim 7, wherein the photo sensor comprises a light barrier which is interruptible by the visual trip indicator.

9. The high-lift system according to claim 1, wherein the RFID tag device is a passive RFID tag device.

10. An aircraft having two wings and at least one high-lift system according to claim 1.
